(19) United States
(12) Patent Application Publication
(10) Pub. No.: US 2010/0261802 A1
(43) Pub. Date: Oct. 14, 2010

(54) Method for Producing Expandable Polystyrene and the Use Thereof

(75) Inventors: Roman Eberstaller, Obergrafendorf (AT); Gerhard Hintermeier, St. Poelten (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sunpor Kunststoff Ges m b H, St Poelten (AT)

(21) Appl. No.: 12/676,593

(22) PCT Filed: Sep. 12, 2008
(86) PCT No.: PCT/AT2008/000326

§ 371 Date: Jun. 30, 2010

(30) Foreign Application Priority Data
Sep. 14, 2007 (AT) A 1447 2007

(51) Int. Cl. C08J 9/16; C08J 9/10

(52) U.S. Cl. 521/56; 521/95; 521/90

(57) ABSTRACT

A method for producing expandable polystyrene (EPS) or extruded polystyrene foams (XPS), starting from polystyrene already present in the polymerized state or polystyrene melts, the same containing at least one expanding agent and/or at least one flame or fire retardant and/or at least one radical former as a flame retarding synergist, either from the start and/or being added during the production process. To reduce the extent to which the molecular weight is decreased as a result of the chain decomposition occurring during the heating as part of the production process, at least one stable free radical from the group of organic nitroxyl radicals of the general formula (1) is added to the polystyrene and/or the melt thereof. In the formula R₁, R₂, R₃, R₄, R₅ and R₆ are either identical or different, linear or branched, optionally substituted alkyl groups, or R₂, R₃, R₅ and R₆ have these meanings, however R₁ and R₄ are closed forming a chain with each other, the chain being made of (—CH₂—)— units or a combination of the (—CH₂—)— units with oxygen and/or nitrogen atoms, the chain optionally being connected to a further saturated, unsaturated, or aromatic ring, wherein the further ring-shaped organic (aliphatic) and/or aromatic structure is optionally substituted. Alternatively, the chain itself carries at least one arbitrary substituent, or at least one compound forming or comprising such a nitroxyl radical of the formula (1) is added to the polystyrene and/or the melt thereof.

The invention relates to expandable polystyrenes (EPS) which can be processed to rigid foam materials of fine cell structure and low density, and to extruded polystyrene foams (XPS), and especially to a new process for producing the same.

Several methods for producing expandable polystyrenes are known. In a suspension polymerization process, expandable polystyrene can be produced via the polymerization of styrene and gassing with an expanding agent.

Expandable or expanded polystyrenes can also be mechanically processed by extruding polymer melts and incorporating an expanding agent into the polymer melt, and then pumping this through a die plate to create extruded EPS granulate, or can be processed by foaming directly downstream of a nozzle to create foamed plates.

Also known are methods in which expandable polystyrenes are generated using static mixing elements (EP 0 668 139).

In the aforementioned mechanical processes, the high temperatures and strong mechanical forces present during melting and pumping always result in decomposition of the polymer chains. The molecular weight of the extruded polystyrenes is generally about 10,000-15,000 g/mol lower than the molecular weight of the originally used polymer. It is now known that this decomposition can be decreased by adding antioxidants and stabilizers.

For example, DE 28 12 350 A describes a method for extruding polystyrene compounds to which sterically hindered phenols and tris(substituted phenol)phosphite have been added for stabilization. This method has proven effective for the extrusion of non-flame retardant crystal polymers and polystyrene from suspension polymerization.

Normally, however, one or more thermal radical formers, such as dicumyl or peroxide, is added as a flame retarding synergist to flame retardant polystyrenes to support a primarily halogenated flame retardant, as is described in patent specification EP 0 374 812 B1, for example. Thermal radical formers with short half-lives at temperatures of 140 to 300° C., such as dicumyl peroxide, di-t-butyl peroxide and t-butyl hydroperoxide, are especially suitable for this.

However, radicals created especially from peroxides and thermal radical formers result in a particularly severe decomposition of the polymer chains during processing—due to the interaction between high temperature and shear stress. For this reason, flame retardant polystyrene, which contains a thermal radical former as synergist in addition to the actual flame retardant, undergoes particularly severe decomposition.

This decomposition can be decreased by increasing the amount of stabilizers or antioxidants added, however, the radicals that are produced are then irreversibly eliminated from the system by the free-radical scavengers contained therein, and are then no longer available as flame retarding synergists. This disadvantage must be compensated for by increasing the amount of flame retardant added.

If synergists are dispensed with entirely, however, an up to ten times greater concentration of flame retardant must be used in order to meet the requirements of standard flame tests.

According to WO 2006/007995 A1, which describes a method for producing flame retardant expandable polystyrene, a method is provided in which an attempt is made to minimize chain decomposition by the shortest possible residence time of the peroxide in the polymer melt, especially less than 15 min. This can be achieved, for example, by not conveying the synergist with the polymer melt over the entire length of the extruder, but adding it only within one of the end zones of the extruder, for example via pumps or a lateral extruder.

However, this process requires high expenditure on equipment and involves the risk of an ultimately non-homogeneous incorporation of the flame retarding synergists into the polystyrene melt. Decomposition caused by radicals that are produced must nevertheless be diminished by free-radical scavengers.

A further disadvantage is that raw materials that already contain peroxides, such as flame retardant polymer regrind or expandable polystyrenes, especially flame retardant expandable polystyrenes, for example boundary fractions from suspension polymerization, cause such severe chain decomposition that these cannot be used as raw materials.

The object of the present invention was thus to find an efficient and gentle process for producing flame retardant expandable or expanded polystyrene containing one or more thermal radical formers as flame retarding synergist, in which only a slight decrease in molecular weight occurs as a result of chain decomposition, and the flame retarding synergist is not irreversibly eliminated from the system.

Surprisingly, the object could be attained by using at least one stable free radical from the group of nitroxyl radicals (nitroxides) of the general formula (1).

The subject of the invention is therefore a new method for producing expandable polystyrenes (EPS) or extruded polystyrene foams (XPS), starting from polystyrenes already present in the polymerized state or polystyrene melts, wherein these contain at least one expanding agent and/or at least one flame or fire retardant and/or at least one radical former as a flame retarding synergist, either from the start and/or being added during the production process, characterized in that
in order to reduce the extent to which the molecular weight is decreased as a result of the chain decomposition occurring during the heating as part of the production process—at least one stable free radical from the group of organic nitroxyl radicals of the general formula (1),

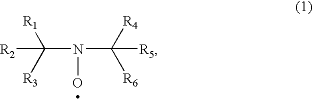

wherein in said formula R₁, R₂, R₃, R₄, R₅ and R₆ are either identical or different, linear or branched, optionally substituted alkyl groups,
or R₂, R₃, R₅ and R₆ have the aforementioned meanings, however R₁ and R₄ are closed forming a chain with each other, the chain being made of (—CH₂—)— units or a combination of the (—CH₂—)— units with oxygen and/or nitrogen atoms, the chain optionally being connected to a further saturated, unsaturated or aromatic ring, wherein this further ring-shaped organic aliphatic and/or aromatic structure is optionally substituted, or the chain itself carries at least one arbitrary substituent,
   or at least one compound comprising or forming such a nitroxyl radical of formula (1) is added to said polystyrene and/or the melt thereof.

A preferred embodiment of the new method is specified in claim 2.

Particularly preferable is the use of nitroxyl radicals of the general formula (2), as specified in claim 3.

Particularly preferred representatives of this type, in which R₁, R₂, R₃ and R₄ are methyl groups, are 2,2,6,6-tetramethylpiperidine-N-oxyl (TEMPO) (Y being a hydrogen atom) and 4-hydroxy-2,2,6,6-tetramethylpiperidine-n-oxyl (HTEMPO) (Y being a hydroxyl group).

One known use for nitroxyl radicals is found in U.S. Pat. No. 4,581,429 A. This publication describes that alkoxyamines, in other words compounds of nitroxyl radicals with a polymerization initiator, can be used for the controlled radical polymerization of styrene monomers. Free radical polymerizations initiated by radical starters proceed very quickly as a result of the low stability of the radical intermediate products. Chain decomposition and transfer reactions also result in a wide molar mass distribution of the resulting polymer chains. By adding representatives of the aforementioned group of substances to the monomers, it is possible to control the growth stages of polymerization and thereby achieve the most uniform molecular weight distribution possible.

This patent specification does not, however, mention the possibility of postponing stabilizing polystyrenes with nitroxyl radicals or compounds thereof until the further processing stage.

Additionally, the following can be stated about the current prior art:

DE 19939031 A1 involves only N-oxyl radicals and their use for the formation of polymers from monomers. These compounds are used in the referenced publication for the control of radical polymerizations, and are intended to lead to higher yields within a shorter time.

The nitroxyl radicals according to this DE-A1 are used to achieve an entirely different objective from that of the present invention: According to this DE-A1, the nitroxyl radicals are used to synthesize or accelerate the synthesis of polymer chains starting from the monomers.

According to the invention, however—in diametric opposition to the object and the goal of the DE-A1—the—prior art—nitroxyl radicals are added to a finished, in other words a fully polymerized polymer, which is already formed with polymer chains of considerable length, in order to effectively counteract a rapid decomposition of the polymer chains, in other words the rapid reduction of the chain length of the polymer as a result of the effects of the increased temperature on the same, during further processing under pressure and at increased temperature, for example in an extruder.

Thus the cited DE-A1 has no relevance to the method of the invention, which provides for the use of the nitroxyl radicals to prevent or decrease chain decomposition in finished polymers or in melts thereof.

Similarly, the subject of DE 19633996 A1 is the addition of these N-oxyl radicals to the monomers in the production of polymers from the same.

Thus this DE-A1 also has no relevance to the present invention.

The subject of DE 102004034516 A1 is a method for producing flame retardant expandable polystyrenes (EPS) by extruding polystyrene melt that contains expanding agents and flame retardants through a die plate, followed by underwater granulation, however the short melting status time of the polymer this DE-A1 attempts to achieve can contribute to a reduction in chain decomposition.

This DE-A1 makes no mention of an addition of a nitroxyl radical, and mentions only the addition of dicumyl and dicumyl peroxide as flame retarding synergists. This DE-A1 therefore also has no relevance to the present invention.

According to JP 1165534 A, nitroxyl radicals are used as polymerization inhibitors for styrene monomers which are subjected to distillation at increased temperatures, for example.

The object of the invention lies not in preventing the polymerization of monomers, but in preventing the overly rapid shortening of the chain length of finished polymers when these are processed at increased temperatures. Thus this JP-A also cannot be viewed as relevant to the present invention.

Finally, SU-1558888 A1 similarly describes only the function of the N-oxyl compounds added to the monomers described therein as polymerization inhibitors, therefore SU-A1 also is not relevant to the invention.

In the production of polystyrenes, the expanding agent is incorporated into the polymer melt, or, when expandable polystyrene produced via suspension polymerization is used as the raw material, the expanding agent is already incorporated into the raw material, and can optionally be increased by adding further expanding agent.

In the context of the present invention, the term “polystyrenes” refers especially to polystyrenes and mixed polymers or copolymers of the styrene with other compounds, such as alpha-methylstyrene, acrylonitrile, maleic acid anhydride, butadiene or divinyl benzene, for example. All polymers having the customary molecular weights may be used.

The production process comprises production of a melt, a sequence of mixing, heating or cooling, pumping and finally granulation and/or foaming.

All of these process steps have long been part of the state of the art in the plastics processing industry and can be performed on or in known equipment and combinations of equipment.

Extruders or static mixers are particularly suited for this, followed by granulation. The granulation process may comprise underwater granulation under pressure, granulation with rotating blades and cooling with cooling fluid or dispersion granulation.

The expanding agent may be a physical expanding agent, such as gaseous hydrocarbons, or hydrocarbons that become gaseous at increased temperatures (including halogenated or partially halogenated hydrocarbons), and which have a boiling point that is below the softening point of the respective polymer. Typical examples of such compounds include propane, butane, pentane and hexane. Water, nitrogen or CO₂ may also be used as an expanding agent. Chemical expanding agents and expanding agents that eliminate volatile constituents—thermally or induced by radiation—may also be used.

Suitable flame retardants include especially halogenated organic compounds having a bromine content greater than 50 w/w. Known examples of these include hexabromocyclododecane or pentabromo monochlorocyclohexane. All other halogenated and halogen-free flame retardants may also be used. Suitable examples of these substances include red phosphorous, organic phosphorous compounds, such as DOP (9,10-dihydro-9-oxa-10-phosphaphenanthrene-10-oxide), organic and inorganic N compounds (e.g., ammonium polyphosphate), inorganic compounds, such as magnesium hydroxide, aluminum hydroxide, water glass or expanding graphite, for example.

The quantity of flame retardant that is used is customarily between 0.1 and 35 w/w. These flame retardants can be used in any combination with the flame retarding synergists listed above.

Additionally, all customary adjuvants, such as UV stabilizers, softeners, pigments, dyes, organic and inorganic fillers, antioxidants and/or acid scavengers may be used in any quantities in the polymer melts. By adding athermanous particles, such as graphite, carbon black, metal oxides, non-metal oxides or aluminum powder, the thermal conductivity of the foamed products can be improved.

The nitroxyl radicals may be added to or in the finished polymer(s) before the melting of the polymers with the remaining compounds as listed above by incorporating these into the same, and/or at a later stage of the polymer melt by adding these inside the extruder or mixer, for example via pumping, lateral extrusion, or stuffing systems. Additionally, the provided nitroxyl radicals may be added to the polymer raw material at the same time, or may already be physically or chemically bonded into the same.

Claim 4 relates to the use of particularly preferred nitroxyl radicals of formula (2).

Claims 5 and 6 concern preferable mass ratios of the nitroxyl radicals to be used in the new polystyrenes.

Claims 7 to 11 contain additional details on the flame retardants and flame retarding synergists that can be or are advantageously used.

Claim 12 lists additives that can be advantageously used.

Preferred expanding agents are disclosed in claims 13 to 16.

Claim 17 lists filler materials that can be advantageously added.

Claims 18 to 20 relate to advantageous processing conditions for the production of the new polystyrenes to which the nitroxyl radicals are added, making them subject to decreased decomposition.

Finally, claims 21 and 22 relate to preferred uses of the polystyrenes produced according to the method of the invention.

The following examples provide greater detail on the invention. The stated percentages are referred to the weight or the mass of the polymer.

### EXAMPLE 1

A flame retardant polystyrene (EPS) produced via suspension polymerization and containing an expanding agent, having a mean molecular weight M_{W} of 200,000 g/mol, which already contains a combination of hexabromocyclododecane (HBCD) (0.8 w/w) and dicumyl peroxide (0.2 w/w), was melted in an extruder.

An additional 1.2 w/w HBCD was added to the polystyrene in the intake area of the extruder. The polymer melt was pumped through a die plate and granulated with a pressurized underwater granulator to compact EPS granulate.

### EXAMPLE 2

The procedure of Example 1 was followed. However, 0.2% of a commercially available plastics stabilizer (Tris(substituted phenol)phosphite) was mixed into the raw materials mixture in the intake area of the extruder.

### EXAMPLE 3

The procedure of Example 1 was followed. However, as provided according to the invention, 0.2% 4-hydroxy-2,2,6,6-tetramethylpiperidine-N-oxyl (HTEMPO) was mixed into the raw materials mixture in the intake area of the extruder.

### EXAMPLE 4

The same raw material as in Example 1 was used. The extrusion conditions were chosen equivalent to those of Example 1. However, no additional flame retardant was added.

### EXAMPLE 5

The procedure of Example 1 was followed. However, a non-flame retardant polystyrene (EPS) containing expanding agent, produced via suspension polymerization, having a mean molecular weight M_{W} of 200,000 g/mol was used. Additionally, 0.2% dicumyl peroxide was added to the mixture in the intake area, and was melted together with the remaining components.

### EXAMPLE 6

The procedure of Example 5 was followed. However, as provided according to the invention, 0.2% 4-hydroxy-2,2,6,6-tetramethylpiperidine-N-oxyl (HTEMPO) was mixed into the raw materials mixture in the intake area of the extruder.

### Results:

| | Mean molecular | Molecular weight | |
|---|---|---|---|
| | weight M_{W} | decrease | Flame test B2 |
| | [kg/mol] or [kDa] | [kg/mol] or [kDa] | DIN 4102 |
| Example 1 | 169 | 31 | Did not pass |
| Example 2 | 171 | 29 | Did not pass |
| Example 3 | 191 | 9 | passed |
| Example 4 | 178 | 22 | Did not pass |
| Example 5 | 135 | 65 | Did not pass |
| Example 6 | 195 | 15 | passed |

The shortening of the polymer chains or the decrease in the mean molecular weights M_{W} in Examples 1 and 2 are significant enough that the obtained products in no way continue to meet thermal and mechanical stability requirements. Formed components produced from these do not pass the flame test according to DIN 4102.

In Example 3, chain decomposition, at 9,000 g/mol, is within a range that is comparable to the customary decomposition of polymer chains. The radicals formed during extrusion can be bonded by the HTEMPO to the extent that they are no longer capable of accelerating chain decomposition reactions, but are available as a flame retarding synergist. Molded components produced from this pass the flame test according to DIN 4102.

In Example 4, the flame retardant system comprised of flame retardant and synergist is weakened enough that it does not pass the flame test according to DIN 4102. In addition, the dicumyl peroxide, which is present as a synergist, causes a clear decomposition of the polymer chains.

The greatest decomposition occurs in Example 5. The flame retardant system is no longer sufficient to pass the flame test.

In Example 6, the decomposition of chain length is relatively low. The requirements of the flame test are met.

1. Method for producing expandable polystyrenes (EPS) or extruded polystyrene foams (XPS), starting from polystyrenes already present in the polymerized state or polystyrene melts, the same containing at least one expanding agent and/or at least one flame or fire retardant and/or at least one radical former as a flame retarding synergist, either from the start and/or being added during the production process, comprising,
in order to reduce the extent to which the molecular weight is decreased as a result of the chain decomposition occurring during the heating as part of the production process, at least one stable free radical from the group of organic nitroxyl radicals of the general formula (1) 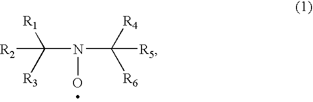
wherein in said formula R₁, R₂, R₃, R₄, R₅ and R₆ are either identical or different, linear or branched, optionally substituted alkyl groups,
or R₂, R₃, R₅ and R₆ have the aforementioned meanings, however R₁ and R₄ are closed forming a chain with each other, the chain being made of (—CH₂—)— units or a combination of the (—CH₂—)— units with oxygen and/or nitrogen atoms, the chain optionally being connected to a further saturated, unsaturated or aromatic ring, wherein this further ring-shaped organic (aliphatic) and/or aromatic structure is optionally substituted, or the chain itself carries at least one arbitrary substituent,
or at least one compound comprising or forming such a nitroxyl radical of formula (1) is added to said polystyrene and/or the melt thereof.

2. Method of claim 1, comprising at least one stable free radical from the group of organic nitroxyl radicals of the general formula (1), wherein R₁, R₂, R₃, R₄, R₅ and R₆ are either identical or different, linear or branched, optionally substituted alkyl groups,
or R₂, R₃, R₅ and R₆ have the aforementioned meanings, however R₁ and R₄ are closed forming a chain with each other, the chain being made of three or four (—CH₂—)— units or a combination of the (—CH₂—)— units with oxygen and/or nitrogen atoms, the chain optionally being connected to a further saturated, unsaturated or aromatic ring, wherein this further ring-shaped organic (aliphatic) and/or aromatic structure is optionally substituted, or the chain itself carries at least one arbitrary substituent,
or at least a compound comprising or forming such a nitroxyl radical of the formula (1) is added to said polystyrene and/or the melt thereof.

3. Method of claim 1, wherein a nitroxyl radical that corresponds to the general formula (2), 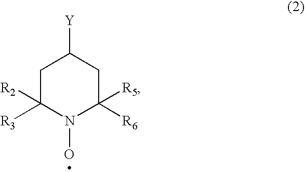
and wherein R₂, R₃, R₅ and R₆ each have the meanings specified in claim 1 and Y is an arbitrary substituent, is used.

4. Method of claim 1, wherein a nitroxyl radical that corresponds to the general formula (2), in which formula R₂, R₃, R₅ and R₆ are methyl groups and Y is an arbitrary substituent, is used.

5. Method of claim 1, wherein the nitroxyl radical of the general formulas (1) and/or (2) is used in a quantity of 0.01 to 10 w/w, especially 0.02 to 2 w/w, in each case referring to the mass of the polystyrene.

6. Method of claim 1, wherein the polystyrene melt contains 0.01 to 10 w/w, especially 0.02 to 2 w/w, of at least one nitroxyl radical of the general formula (1), either from the start, and/or the nitroxyl radical is added to or mixed into the same in this quantity.

7. Method of claim 1, wherein the polystyrene melt contains a flame retardant, preferably in a quantity of 0.1 to 10 w/w.

8. Method of claim 1, wherein an organic halogen compound, preferably having a halogen content of at least 50 w/w, is used as the flame retardant in the polystyrene melt.

9. Method of claim 1, wherein a halogen-free flame retardant is used as the flame retardant in the polystyrene melt.

10. Method of claim 1, wherein at least one thermal radical former is used as the flame retarding synergist in the polystyrene melt.

11. Method of claim 1, wherein an organic peroxide, especially dicumyl peroxide or di(-2-(tert-butylperoxy)prop-2-yl)benzene, is used as the thermal radical former.

12. Method of claim 1, wherein materials that increase infrared radiation damping or heat damping properties, such as graphite, carbon black or aluminum, are incorporated into the polystyrene melt.

13. Method of claim 1, wherein a physical expanding agent is added to the polystyrene melt, or wherein a polystyrene or a polystyrene melt to which an expanding agent of this type has already been added is used.

14. Method of claim 1, wherein a gaseous or liquid hydrocarbon is added to the polystyrene melt as the expanding agent, or wherein a polystyrene or a polystyrene melt to which an expanding agent of this type has already been added is used.

15. Method of claim 1, wherein a halogenated or partially halogenated hydrocarbon is added to the polystyrene melt as the expanding agent, or wherein a polystyrene or a polystyrene melt to which an expanding agent of this type has already been added is used.

16. Method of claim 1, wherein a chemical expanding agent or expanding agents that eliminate volatile constituents thermally or induced by radiation are added to the polystyrene or the polystyrene melt.

17. Method of claim 1, wherein organic and/or inorganic fillers are added to the polystyrene or the polystyrene melt.

18. Method of claim 1, wherein the polystyrene melt is brought to a mass temperature of between 130 and 250° C.

19. Method of claim 1, wherein a homogeneous distribution of the nitroxyl radical of the general formulas (1) or (2) in the polystyrene melt is performed in the extruder or in a static mixer.

20. Method of claim 1, wherein in the production of granulates from the expandable polystyrenes (EPS) to which the additives, including the flame retardant and the nitroxyl radicals of the general formulas (1) or (2), have been added, a granulation of the same is performed via underwater granulation.

21. Use of the expandable polystyrenes (EPS) produced according to one of the methods according to claim 1, and present as granulates, to produce polystyrene foam particles and articles or objects having a density of 5 to 80 kg/m³.

22. Use of the extruded polystyrene foams (XPS) produced according to one of the methods according to claim 1, and present in the form of granulates, to produce articles or objects having a density of 10 to 120 kg/m³.
